(19) United States
(12) Patent Application Publication
(10) Pub. No.: US 2023/0133919 A1
(43) Pub. Date: May 4, 2023

(54) COMPOSITIONS AND RELATED METHODS FOR REDUCING VAPOR EFFECT OF VOLATILE HERBICIDES

(71) Applicant: BOARD OF TRUSTEES OF MICHIGAN STATE UNIVERSITY, East Lansing, MI (US)

(72) Inventor: Donald Penner, Williamston, MI (US)

(21) Appl. No.: 17/915,539

(22) PCT Filed: Mar. 31, 2021
(86) PCT No.: PCT/US21/25028

§ 371 Date: Sep. 29, 2022

Related U.S. Application Data
(60) Provisional application No. 63/004,848, filed on Apr. 3, 2020.

(51) Int. Cl. A01N 25/32; A01N 37/10

(52) U.S. Cl. CPC A01N 25/32; A01N 37/10

(57) ABSTRACT

The disclosure relates to photosensitizer- and herbicide-containing compositions and related methods for reducing the vapor effect of volatile herbicides and other phytotoxic materials on sensitive, desirable plants. The compositions can include a photosensitizer such as riboflavin and a volatile growth regulator herbicide. The composition can be applied to a target area to control an undesired herbicide-sensitive target plant in the area with the herbicide. The presence of the photosensitizer in the composition reduces he vapor effect of the volatile herbicide or other atmospheric phytoxicant. A reduced vapor effect reduces damage to other desired sensitive plants, whether inside or outside of the target area of application. The compositions are suitably aqueous, for example in a relatively concentrated form for dilution or in a relatively dilute form for spraying.

### CROSS REFERENCE TO RELATED APPLICATION

Priority is claimed to U.S. Provisional Application No. 63/004,848 (filed Apr. 3, 2020), which is incorporated herein by reference in its entirety.

### STATEMENT OF GOVERNMENT INTEREST

None.

### BACKGROUND OF THE DISCLOSURE

### Field of the Disclosure

The disclosure generally relates to compositions and related methods for reducing the vapor effect of volatile herbicides and other phytotoxic materials. The compositions generally include a photosensitizer compound such as riboflavin, analog thereof, or derivative thereof.

### Brief Description of Related Technology

Volatilization of herbicides from soils and plants can result in undesirable loss of the active herbicide ingredient as well as unintended injury to nearby plants. Volatile growth regulator herbicides such as 2,4-D as well can cause damage to neighboring, herbicide-sensitive plants resulting from volatile transport of the herbicide within its intended target area and to other neighboring areas including the herbicide-sensitive plants. Similarly, gaseous or atmospheric phytotoxicants other than volatile herbicides can cause damage to sensitive plants.

Penner et al. U.S. Pat. No. 5,945,377 discloses compositions incorporating a non-volatile, post-emergence herbicide and a monosaccharide, particularly fructose, as a potentiator of the herbicide against weeds without decreasing tolerance of a crop plant to the herbicide. The compositions are used as a spray in water in a method for killing weeds.

Penner U.S. Pat. No. 10,492,490 is directed to adjuvant compositions and related methods for reducing herbicide volatility. The compositions include a volatile growth regulator herbicide and a monosaccharide adjuvant. When the compositions are applied to a target area to control a herbicide-sensitive target plant in the area with the herbicide, the monosaccharide adjuvant reduces volatile transport of the herbicide.

### SUMMARY

The disclosure relates to photosensitizer- and herbicide-containing compositions and related methods for reducing the vapor effect of volatile herbicides and other phytotoxic materials on sensitive, desirable plants. The compositions can include a photosensitizer such as riboflavin and a volatile growth regulator herbicide. The composition can be applied to a target area to control an undesired herbicide-sensitive target plant in the area with the herbicide. The presence of the photosensitizer in the composition reduces the vapor effect of the volatile herbicide or other atmospheric phytoxicant. A reduced vapor effect reduces damage to other desired sensitive plants, whether inside or outside of the target area of application. The compositions are suitably aqueous, and they can be in a relatively concentrated form (e.g., intended to be diluted with water, optionally with the addition of other additives or adjuvants prior to use) or in a relatively dilute form (e.g., at concentrations suitable for spraying or other application to a target area without dilution).

In one aspect, the disclosure relates to a method for reducing vapor effect of volatile herbicides, the method comprising: (a) providing a composition comprising: (i) water, (ii) a volatile growth regulator herbicide, and (iii) a photosensitizer selected from the group consisting of flavins, flavonoids, derivatives thereof (e.g., riboflavin), and combinations thereof; (b) applying the composition to a target area comprising: (i) optionally a first desired plant which is resistant or tolerant to the volatile growth regulator herbicide, and (ii) an undesired plant which is to be targeted by the volatile growth regulator herbicide and which is sensitive to the volatile growth regulator herbicide; and (c) controlling the undesired plant in the target area with the applied composition; wherein the vapor effect of the volatile growth regulator herbicide in the target area (e.g., herbicide volatility from plant substrates and/or soil to which herbicide is applied in the target area) is reduced or eliminated relative to a corresponding composition without the photosensitizer applied to the target area. In a refinement, the photosensitizer comprises riboflavin. In another refinement, the volatile growth regulator herbicide comprises one or more of 2,4-dichlorophenoxyacetic acid (2,4-D), 3,6-dichloro-2-methoxybenzoic acid (dicamba), and derivatives thereof. In another refinement, the composition can consist of or consist essentially of (i) water, (ii) one or more volatile growth regulator herbicides (e.g., 0.1 wt. % to 10 wt. %), (iii) one or more photosensitizers (e.g., 0.01 wt. % to 10 wt. %), (iv) optionally one or more non-volatile growth regulator herbicides, and (v) optionally one or more adjuvants (e.g., monosaccharides, water conditioners, surfactants, antifoaming agents, anti-drift agents).

In one aspect, the disclosure relates to a method for reducing vapor effect of phytotoxicants (e.g., volatile herbicides), the method comprising: (a) providing a first composition comprising: (i) water and (ii) a photosensitizer selected from the group consisting of flavins, flavonoids, derivatives thereof (e.g., riboflavin), and combinations thereof (e.g., the first composition is free from volatile growth regulator or other herbicides); (b) applying the first composition to a collateral area comprising a first desired plant which is to be protected from a phytotoxicant (e.g., volatile growth regulator herbicide or other atmospheric phytotoxicant) and which is sensitive to the phytotoxicant; and (c) reducing or eliminating via the photosensitizer the vapor effect of the phytotoxicant in the collateral area and on the first desired plant (e.g., volatile herbicide or other phytotoxicant adsorbed on to plant or other surfaces in the target area having the photosensitizer thereon) relative to a corresponding first desired plant without the photosensitizer applied to the collateral area. In some embodiments, the method further comprises (d) providing a second composition comprising: (i) water, and (ii) a volatile growth regulator herbicide; (e) applying the second composition to a target area adjacent to the collateral area, the target area comprising: (i) optionally a second desired plant which is resistant or tolerant to the volatile growth regulator herbicide, and (ii) an undesired plant which is to be targeted by the volatile growth regulator herbicide and which is sensitive to the volatile growth regulator herbicide; and (f) controlling the undesired plant in the target area with the applied second composition; wherein at least a portion of the volatile growth regulator herbicide applied in the target area volatilizes and is transported to the collateral area, in which the vapor effect of the volatile growth regulator herbicide is reduced or eliminated by the photosensitizer applied to the collateral area. In a refinement, the phytotoxicant comprises a volatile growth regulator herbicide, such as or more of 2,4-dichlorophenoxyacetic acid (2,4-D), 3,6-dichloro-2-methoxybenzoic acid (dicamba), and derivatives thereof. In another refinement, the first composition can consist of or consist essentially of (i) water, (ii) one or more photosensitizers (e.g., 0.01 wt. % to 10 wt. %), and (iii) optionally one or more adjuvants (e.g., monosaccharides, water conditioners, surfactants, antifoaming agents, anti-drift agents). In another refinement, the second composition can consist of or consist essentially of (i) water, (ii) one or more volatile growth regulator herbicides (e.g., 0.1 wt. % to 10 wt. %), (iii) optionally one or more non-volatile growth regulator herbicides, and (iv) optionally one or more adjuvants (e.g., monosaccharides, water conditioners, surfactants, antifoaming agents, anti-drift agents).

In another aspect, the disclosure relates to a composition comprising: (a) water; (b) a volatile growth regulator herbicide; (c) a photosensitizer selected from the group consisting of flavins, flavonoids, derivatives thereof, and combinations thereof; and (d) optionally a monosaccharide; wherein the vapor effect of the volatile growth regulator herbicide from a target area to which the composition is applied is reduced or eliminated relative to a corresponding composition without the photosensitizer applied to the target area or plant substrate (e.g., reduced herbicide volatility from plant substrates and/or soil to which herbicide is applied in the target area). In a refinement, the volatile growth regulator herbicide and the photosensitizer are present in the composition at concentrations suitable for application to a target area comprising an undesired plant which is to be targeted by the volatile growth regulator herbicide and which is sensitive to the volatile growth regulator herbicide. In another refinement, the volatile growth regulator herbicide and the photosensitizer are present in the composition at elevated concentrations unsuitable without prior dilution for application to a target area comprising an undesired plant which is to be targeted by the volatile growth regulator herbicide and which is sensitive to the volatile growth regulator herbicide. In another refinement, the photosensitizer comprises riboflavin. In another refinement, the volatile growth regulator herbicide comprises one or more of 2,4-dichlorophenoxyacetic acid (2,4-D), 3,6-dichloro-2-methoxybenzoic acid (dicamba), and derivatives thereof. In another refinement, the composition can consist of or consist essentially of (a) water, (b) one or more volatile growth regulator herbicides (e.g., 0.1 wt. % to 10 wt. %), (c) one or more photosensitizers (e.g., 0.01 wt. % to 10 wt. %), (d) optionally one or more monosaccharides (e.g., 0.01 wt. % to 10 wt. %), (e) optionally one or more non-volatile growth regulator herbicides, and (f) optionally one or more adjuvants (e.g., water conditioners, surfactants, antifoaming agents, anti-drift agents).

While the disclosed methods and compositions are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### DETAILED DESCRIPTION

Continuous application of glyphosate for weed control, year after year, has resulted in the selection of weeds resistant to glyphosate. Soybeans have been bioengineered to now have resistance to one or both of the volatile growth regulator herbicides 2,4-D and dicamba. These herbicides have utility in controlling broad-leaved weeds resistance to glyphosate in soybean production. The application of these herbicides is not without some problems. Herbicide volatility, in particular, can be a substantial problem affecting nearby desirable/non-weed plants sensitive to the herbicide. Spray drift during application can be addressed with judicious choices of nozzle, nozzle tip, and drift-retardant spray adjuvants. The drift problem has also been imperfectly addressed by restricting application of these herbicides under certain conditions and by varying field border regiments. The disclosed compositions and methods provide another way to reduce the hazards for herbicide vapor movement from the application site to non-target sites. Photosensitizer compounds such as riboflavin and its derivatives can photo-oxidize these herbicides and other atmospheric phytotoxicants and reduce their phytotoxicity from vapors. The examples below demonstrate this reduced herbicide activity from the herbicide's volatility, from both soybean leaves and from bare soil, when riboflavin is present in a spray solution with a volatile herbicide. The inclusion of riboflavin in the herbicide spray solution did not reduce the efficacy of the herbicide on weeds.

The disclosure relates to photosensitizer- and herbicide-containing compositions and related methods for reducing the vapor effect of volatile herbicides and other phytotoxic materials on sensitive, desirable plants (i.e., non-weed plants). The composition includes a volatile growth regulator herbicide (e.g., 2,4-D, dicamba, and derivatives or analogs thereof) and a photosensitizer (e.g., riboflavin), typically in an aqueous solution or mixture. The composition can be applied to a target area to control an (undesired) herbicide-sensitive target plant in the area with the herbicide. The presence of the photosensitizer in the composition reduces the vapor effect of the volatile herbicide or other atmospheric phytoxicant, for example by photolytically degrading or otherwise converting the volatile herbicide or phytoxicant to a less toxic or non-toxic form. Reduced vapor effect and/or conversion to less toxic forms can reduce damage to other (desired) non-target herbicide- or phytoxicant-sensitive plants, whether inside or outside of the target area of application. In some embodiments, the composition can include the photosensitizer, but not the volatile growth regulator herbicide. Such embodiments can be useful when the composition protects a sensitive plant from atmospheric phytoxicants generally present and/or from volatile herbicides applied to a neighboring area that could otherwise damage the sensitive plant.

In one aspect, the disclosure relates to a composition including: (a) water; (b) one or more volatile growth regulator herbicides; and (c) one or more photosensitizers. As noted above, the vapor effect of the volatile growth regulator herbicide from a target area to which the composition is applied is reduced or eliminated (e.g., reduced vapor effect of volatile herbicides from plant substrates and/or soil to which herbicide is applied in the target area), for example relative to a corresponding composition without the photosensitizer applied to the target area (i.e., an otherwise identical composition but without the photosensitizer). In a refinement, a reduction in vapor effect can be characterized as illustrated in the examples below, for example using soybean plants (e.g., or equivalent herbicide-tolerant plants) and herbicide-sensitive plants in a plant growth chamber or other controlled plant growth environment with a selected herbicide composition including a volatile growth regulator herbicide and a photosensitizer. Suitably, the herbicide composition including the photosensitizer can result in an injury level at 7-DAT, 10-DAT, 14-DAT, and/or 21-DAT for herbicide-sensitive plants which is about 80%, 50% or 30% or less and/or at least about 5%, 10%, 20%, 30%, or 40% of the injury level for the corresponding composition without the photosensitizer.

The photosensitizer can include one or more compounds such as flavins, flavonoids, porphyrins, derivatives thereof (e.g., riboflavin), and mixtures thereof. Without being bound by a particular theory, is believed that photosensitizer compounds such as flavin compounds, flavonoid compounds can be activated by absorption of sunlight (UV-range wavelength radiation in particular) to donate or release an electron, which free electron can degrade or convert a volatile herbicide or other phytoxicant into a less or non-toxic form. Thus, when compositions containing the photosensitizer are applied in an external (outside) environment, natural sunlight can be sufficient for the photosensitizer to exert its reduction in vapor effect on environmental phytotoxicants. A generic flavin structure is shown below, and the photosensitizer can include various flavin derivatives such as riboflavin (i.e., with R as a tetrahydroxy pentyl group), flavin mononucleotide (or FMN; 5′-phosphorylated ester of riboflavin), flavin adenine dinucleotide (FAD) and reduced forms thereof (e.g., FADH, FADH₂). The photosensitizer additionally can include various polyphenolic compounds such as various flavonoids and related derivatives. Flavonoids include oxygen-containing heterocyclic structures typically with one or more ketone groups thereon and//or one or more hydroxy groups thereon (i.e., as a phenolic hydroxy group). Examples of flavonoids include anthocyanidins (e.g., cyanidin, delphinidin, malvidin, pelargonidin, peonidin, petunidin), flavones (e.g., luteolin, apigenin, tangeritin), flavonols (e.g., quercetin, kaempferol, myricetin, fisetin, galangin, isorhamnetin, pachypodol, rhamnazin, pyranoflavonols, furanoflavonols), flavanones (e.g., hesperetin, naringenin, eriodictyol, homoeriodictyol), flavanonols (e.g., taxifolin (or dihydroquercetin), dihydrokaempferol), and flavans (e.g., catechin, gallocatechin, catechin 3-gallate, gallocatechin 3-gallate, epicatechins, epigallocatechin, epicatechin 3-gallate, epigallocatechin 3-gallate). The photosensitizer additionally can include various porphyrin compounds, for example with or without a complexed metal cation.

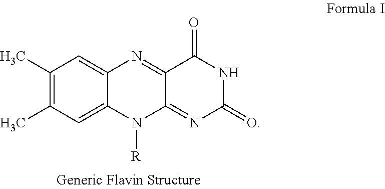

Photosensitizers such as riboflavin do not necessarily reduce the vapor effect of the herbicides by reducing volatility or otherwise limiting the ability of the herbicide to enter the vapor phase. Instead, it is believed that the photosensitizer acts in combination with light (e.g., sunlight) to photolytically degrade or otherwise convert a volatile herbicide or other phytotoxicant to a less toxic or non-toxic form, such that vapor transport of the less- or non-toxic form of the photolytic degradation product does not harm neighboring sensitive plants as would the original herbicide or phytotoxicant. Thus, a reduction of vapor effect reflects photolytic conversion of volatile herbicides and other phytotoxicants (i.e., that would be susceptible to volatile transport) to one or more other reaction products that do not (substantially) damage sensitive neighboring plants if they do volatilize and/or are less volatile or non-volatile relative to the original compound. Photosensitizers such as riboflavin on a substrate (e.g., ground, target plant, non-target plant, or wherever else applied) has the ability to photolytically degrade herbicides and other phytotoxicants also on the substrate, for example a herbicide that is co-applied with the photosensitizer, but which is not absorbed into the substrate (i.e., remaining on the substrate surface with the photosensitizer). In addition, the photosensitizer has the ability to act upon herbicides and other phytotoxicants that were not co-applied with the riboflavin. For example, herbicide vapors and phytotoxicants that have volatilized from a nearby area can be adsorbed or otherwise captured on a surface containing the photosensitizer, whereupon the captured herbicide and/or phytotoxicant vapor can be degraded by the photolytic action with photosensitizer where it is adsorbed.

In one aspect and as described in more detail herein, the photosensitizer can be added to the volatile herbicide mixture, and the two can be applied together to a given area, which is a target area including at least one undesired plant (e.g., weed) to be killed etc. by the herbicide. In a first mode of action, the photosensitizer can act in place on the volatile herbicide that is co-applied with the photosensitizer, but which is not absorbed into the plant. This can degrade/deactivate the herbicide before it volatilizes, which reflects a reduction of vapor effect, because there is less free herbicide able to volatilize. Thus, while the degradation product might itself volatilize, there is less non-absorbed surface herbicide able to enter the vapor phase and damage other nearby pants. In a second mode of action, the photosensitizer can also act to capture herbicide that volatilizes from a nearby area, but which is captured/degraded before the herbicide can travel sufficiently far enough to a neighboring area where it can damage sensitive plants. This can occur, for example, where herbicide to a low/dark/shadowy area volatilizes, for example where there is not much sunlight to activate the photosensitizer degradation near the ground, but the volatilized herbicide is captured on taller plant surfaces near the point of application and with access to sunlight, thus degrading the herbicide before it can escape to a neighboring area with sensitive plants.

In another aspect and as described in more detail herein, the second mode of action above can be employed in embodiment in which sensitive plants are protected by applying volatile herbicides and other atmospheric phytotoxicants by applying the photosensitizer (e.g., without herbicide) to an area with sensitive plants and/or on the sensitive plants therein. A volatile herbicide composition (e.g., without photosensitizer) can be applied to a target area containing weeds, which is neighboring or adjacent to the area with sensitive plants. Thus, the photosensitizer application can be a protective or prophylactic application, independent of herbicide application. For example, a grower or other user could apply the photosensitizer to sensitive plants in an area to protect the sensitive plants from volatile herbicides and other volatile atmospheric phytotoxicants, knowing that other growers or users in neighboring areas are applying volatile herbicides to target weeds in the neighboring areas. Similarly, the same grower or user could be in control of both areas and applying the riboflavin solution and the herbicide solution separately in the two neighboring areas.

The specific amount of the photosensitizer in the herbicide composition or other composition is not particularly limited. Suitably, the photosensitizer is present in the composition in an amount ranging from 0.01 wt. % to 10 wt. %, such as 0.1 wt. % to 10 wt. %, 0.5 wt. % to 5 wt. %, or 0.7 wt. % to 3 wt. %. In various embodiments, the photosensitizer is present in an amount of at least about 0.01 wt. %, 0.1 wt. %, 0.2 wt. %, 0.5 wt. %, 0.7 wt. %, or 1 wt. % and/or up to about 1 wt. %, 1.5 wt. %, 2 wt. %, 3 wt. %, 5 wt. % or 10 wt. % relative the composition as a whole. The foregoing amounts can apply to photosensitizer species individually or all photosensitizers collectively present.

Alternatively or additionally, the photosensitizer amount in the composition can be expressed as a ratio (e.g., weight ratio) of photosensitizer to volatile growth regulator herbicide (e.g., total photosensitizers, total volatile growth regulator herbicides) in the composition. Suitably, the photosensitizer:volatile growth regulator herbicide ratio is in a range of 1:100 to 1:1, for example 1:10 to 1:2 or about 1:5. In various embodiments, the ratio can be at least 1:100, 1:20, 1:10, 1:8, 1:5, or 1:2 and/or up to 1:20, 1:10, 1:8, 1:5, 1:2, or 1:1.

The photosensitizer is suitable for reducing the vapor effect of a variety of volatile or gaseous phytotoxicants, for example including volatile growth regulator herbicides and other atmospheric phytotoxicants. Volatile growth regulator herbicides are described in more detail below. Phytotoxicants generally include substances that toxic or otherwise injurious to plants, in particular substances in gaseous form that can be present in the environment surrounding plants (e.g., atmospheric phytotoxicants). Examples of phytoxicants can include volatile organic compounds, for example volatile organic solvents such as those used in paints, coatings, and other compositions. Examples of such volatile organic solvents include alcohols (e.g., butanol, propanol), glycol ethers (e.g., 2-butoxyethanol), esters (e.g., ethyl acetate, butyl acetate), ketones (e.g., acetone, methyl ethyl ketone), and hydrocarbons such as alkanes (e.g., hexane), aromatics (e.g., toluene, ethylbenzene, xylenes), mineral spirits, etc.

Volatile growth regulator herbicides often function in a manner similar to plant growth regulators or hormones, and they can operate to induce uncontrolled or unsustainable growth to damage and/or kill plants sensitive to the herbicide. Common volatile growth regulator herbicides include phenoxy herbicides (e.g., organochlorine phenoxy herbicides) such as phenoxy-acetic acids, phenoxy-butyric acids, derivatives thereof, and combinations thereof. A volatile growth regulator herbicide can include a weak acid herbicide or a derivative thereof (e.g., including a weak acid group such as a carboxylic acid group such as an acetic acid or a butyric acid group). The herbicide can be in its acid form, in a derivative form, or in a combination of multiple forms (e.g., multiple forms added to the aqueous herbicide composition or multiple forms resulting from chemical equilibria in aqueous herbicide composition). Example herbicide derivative forms include salts (e.g., metal salt such as alkali and/or alkali earth metal salt; amine salt such as mono-, di-, or tri-alkyl or alkanol amine (C₁, C₂, C₃ or C₄ alkyl/alkanol groups such as methyl/methanol, ethyl/ethanol, isopropyl/isopropanol such as in dimethylamine, diethanolamine, isopropylamine, triisopropanolamine salts); organic salt such as choline (e.g., including alkyl, alkanol, and amine/ammonium groups)), esters (e.g., alkyl esters (C₁ or C₃ to C₈ or C₁₂ alkyl groups such as isopropyl, ethylhexyl), and amides. As noted, the specific form of the herbicide and its derivatives can relate to the form as supplied to or the form as present in the aqueous herbicide composition resulting from the various equilibrium reactions with the herbicide as supplied, (ionic) species in the water used (e.g., Ca²⁺ and/or Mg²⁺ in hard water), (ionic) species added to the herbicide composition (e.g., water conditioners, surfactants), and pH conditions of the herbicide composition (e.g., commonly pH from 2 to 7.5 or 4.5 to 7.5). Additionally or alternatively, the herbicide can include an aromatic and/or a heteroaromatic group (e.g., benzene- or pyridine-based group as characteristic of common plant hormone-type herbicides, such as the phenoxy family of herbicides, in particular organochlorine phenoxy herbicides).

Examples of suitable volatile growth regulator herbicides include 2,4-dichlorophenoxyacetic acid (2,4-D), 2,4,5-trichlorophenoxyacetic acid (2,4,5-T), 2-methyl-4-chlorophenoxyacetic acid (MCPA), 2-(2-methyl-4-chlorophenoxy)propionic acid (mecoprop, MCPP), 4-(4-chloro-o-tolyloxy)butyric acid (MCPB), 2-(2,4-dichlorophenoxy)propionic acid (dichlorprop, 2,4-DP), (2,4-dichlorophenoxy)butyric acid (2,4-DB), 3,6-dichloro-2-methoxybenzoic acid (dicamba), 4-amino-3,5,6-trichloropicolinic acid (picloram), 3,5,6-trichloro-2-pyridinyloxyacetic acid (triclopyr), 3,6-dichloro-2-pyridinecarboxylic acid (clopyralid), derivatives thereof, and combinations thereof. In some embodiments, the herbicide composition can include more than one type of volatile growth regulator herbicide (e.g., two, three, or four different types of volatile growth regulator herbicides in admixture). In other embodiments, the herbicide composition includes only one type of volatile growth regulator herbicide (e.g., a single type but possibly including one or more of an acid, salt, and ester form of the herbicide type). In an embodiment, 2,4-D and derivatives thereof are the only volatile growth regulator herbicides in the herbicide composition. In an embodiment, dicamba and derivatives thereof are the only volatile growth regulator herbicides in the herbicide composition.

The volatility of the volatile growth regulator herbicide more generally can be characterized in terms of its vapor pressure in the aqueous herbicide composition (e.g., in the form as present in the composition, if different from the form as added the composition). The vapor pressure of the herbicide can be at least 1×10⁻⁶ Pa, 1×10⁻⁵ Pa, 1.3×10⁻⁵ Pa, 1.5×10⁻⁵ Pa, 1.8×10⁻⁵ Pa, 1×10⁻⁴ Pa, or 1×10⁻³ Pa and/or up to 1×10⁻⁴ Pa, 1×10⁻³ Pa, 1×10⁻² Pa, 1×10⁻¹ Pa, 1×10⁰ Pa, or 1×10¹ Pa. By way of illustration, approximate vapor pressures of common forms of 2,4-D include 1.9×10⁻⁵ Pa (acid), 1.3×10⁻⁵ Pa (dimethylamine salt), 3.2×10⁻⁴ Pa (butoxyethyl ester), 4.8×10⁻⁴ Pa (2-ethylhexyl ester), and 1.9×10¹ Pa (isopropyl ester). Other common forms of 2,4-D that can form the corresponding volatile acid in an aqueous solution include metal salts (e.g., alkali and alkali metal salts such as the sodium salt), the isopropylamine salt, and the triisopropanolamine salt.

The specific amount of the volatile growth regulator herbicide in the herbicide composition is not particularly limited, for example generally being guided by herbicide manufacturer-recommended application rates and the intended target plant. Suitably, the herbicide is present in the composition in an amount ranging from 0.01 wt. % to 10 wt. % (e.g., 0.1 wt. % to 5 wt. %). In various embodiments, the herbicide is present in an amount of at least about 0.01 wt. %, 0.1 wt. %, 0.2 wt. %, 0.5 wt. %, 0.7 wt. %, or 1 wt. % and/or up to about 1.5 wt. %, 2 wt. %, 3 wt. %, 5 wt. % or 10 wt. % relative the composition as a whole. The foregoing amounts can apply to herbicide species individually or all herbicide species collectively present (e.g., multiple forms of the same type of herbicide and/or multiple types of different herbicides).

In some embodiments, the herbicide composition includes an additional herbicide which is not a volatile growth regulator herbicide. For example, the composition can include one or more non-volatile growth regulator herbicides (e.g., non-volatile herbicides and/or non-growth regulator herbicides) such as those disclosed in U.S. Pat. No. 5,945,377, incorporated herein by reference in its entirety. In an embodiment, the additional herbicide can include an amino acid derivative herbicide, for example a glyphosate herbicide (e.g., N-(phosphonomethyl)glycine (glyphosate) including various salts and other derivatives thereof). Alternatively, the herbicide composition can be free of non-volatile growth regulator herbicides.

The compositions according to the disclosure, whether including a volatile growth regulator herbicide, a photosensitizer, or both, can further include a monosaccharide. The monosaccharide can reduce volatile transport of a volatile growth regulator herbicide from the composition containing the monosaccharide. The monosaccharide suitably includes one or more of fructose, glucose, and mannose, in particular including fructose alone or in combination with glucose. In some embodiments, fructose or fructose and glucose is/are the only monosaccharide(s) (or saccharide(s) more generally) in the composition (e.g., the composition is free from other (added) monosaccharides or saccharides more generally). Alternatively or additionally, the monosaccharide can include a corn syrup product such as high-fructose corn syrup. High-fructose corn syrup (HFCS) suitably includes at least 40 wt. %, 50 wt. %, or 60 wt. % and/or up to 50 wt. %, 60 wt. %, 70 wt. % or 90 wt. % fructose relative to total monosaccharides (e.g., balance glucose) in the syrup. Examples include HFCS 42/58, 55/45, or 90/10 or blends thereof (e.g., about 20 wt. %, 25 wt. %, or 30 wt. % water with the substantial balance being a combination of fructose and glucose in the indicated w/w ratio). For example, the ratio of fructose/glucose (w/w) can be 40/60 to 45/55, 40/60 to 60/40, 50/50 to 60/40, 40/60 to 90/10, about 42/58, about 55/45, or about 90/10. In some embodiments, where the high-fructose corn syrup is the only source of monosaccharides or saccharides in the herbicide composition. In other embodiments, the herbicide composition is free or substantially free from saccharides other than the monosaccharide (e.g., free from disaccharides such as sucrose, free from other oligosaccharides (such as 3-10 saccharide units), free from other polysaccharides (such as more than 10 saccharide units), such as having no added saccharides of the indicated type).

The specific amount of the monosaccharide in the herbicide composition is not particularly limited. Suitably, the monosaccharide is present in the composition in an amount ranging from 0.1 wt. % to 10 wt. % (e.g., 0.5 wt. % to 5 wt. % or 0.7 wt. % to 3 wt. %). In various embodiments, the monosaccharide is present in an amount of at least about 0.1 wt. %, 0.2 wt. %, 0.5 wt. %, 0.7 wt. %, or 1 wt. % and/or up to about 1.5 wt. %, 2 wt. %, 3 wt. %, 5 wt. % or 10 wt. % relative the composition as a whole. The foregoing amounts can apply to monosaccharide species individually or all monosaccharide species collectively present (e.g., fructose and glucose combined).

The herbicide composition additional can contain one or more additives or adjuvants known in the art and at commonly employed levels for the same. For example, the composition can include one or more water conditioners (e.g., ammonium sulfate and/or ammonium nitrate for hard water management), one or more surfactants (e.g., nonionic, anionic, cationic), one or more antifoaming agents (e.g., siloxanes such as polydimethylsiloxane), one or more anti-drift agents (e.g., polyvinyl polymers such as polyacylamide), etc. The additives can be included in any suitable amount, for example in an amount ranging from 0.01 wt. % to 10 wt. % (e.g., 0.1 wt. % to 5 wt. %).

The disclosure also relates to methods for reducing the vapor effect of volatile herbicides and other phytotoxicants. In one aspect, a method includes: (a) providing a composition containing a photosensitizer and a volatile growth regulator herbicide according to any of the variously disclosed embodiments and refinements; (b) applying the composition to a target area including: (i) (optionally) a first desired plant which is resistant or tolerant to the volatile growth regulator herbicide, and (ii) an undesired plant (e.g., a post-emergent undesired plant) which is to be targeted by the volatile growth regulator herbicide and which is sensitive to the volatile growth regulator herbicide; and (c) controlling the undesired plant in the target area with the applied composition. The vapor effect of the volatile growth regulator herbicide in the target area is reduced or eliminated relative to a corresponding composition without the photosensitizer applied to the target area. The reduced vapor effect can be characterized by a reduction in damage to herbicide-sensitive desired plants in a neighboring or adjacent area to the target area of application. In another aspect, a method includes: (a) providing a first composition containing a photosensitizer according to any of the variously disclosed embodiments and refinements (e.g., generally being free from volatile growth regulator or other herbicides); (b) applying the first composition to a collateral area including a first desired plant which is to be protected from a phytotoxicant (e.g., volatile growth regulator herbicide or other atmospheric phytotoxicant) and which is sensitive to the phytotoxicant; and (c) reducing or eliminating via the photosensitizer the vapor effect of the phytotoxicant in the collateral area and on the first desired plant relative to a corresponding first desired plant without the photosensitizer applied to the collateral area (e.g., reducing the volatile effect of a volatile herbicide or other phytotoxicant adsorbed on the plant or other surfaces in the target area having the photosensitizer thereon). In an extension of this aspect, the method can further include: (d) providing a second composition containing a volatile growth regulator herbicide according to any of the variously disclosed embodiments and refinements (e.g., generally being free from a photosensitizer); (e) applying the second composition to a target area adjacent to the collateral area, the target area including (i) optionally a second desired plant which is resistant or tolerant to the volatile growth regulator herbicide, and (ii) an undesired plant which is to be targeted by the volatile growth regulator herbicide and which is sensitive to the volatile growth regulator herbicide; and (f) controlling the undesired plant in the target area with the applied second composition. At least a portion of the volatile growth regulator herbicide applied in the target area volatilizes and is transported to the collateral area, in which the vapor effect of the volatile growth regulator herbicide is reduced or eliminated by the photosensitizer applied to the collateral area. When applying the herbicide-containing composition to the target area in either aspect, the composition can be applied to one or more of a surface the undesired plant (e.g., leaves/stalks), soil surrounding the undesired plant (e.g., pre- or post-emergent), a surface of the desired plant in the target area, when present (e.g., leaves/stalks), and/or soil surrounding the desired plant in the target area, when present.

As described above relative the composition, a reduction in vapor effect can be characterized as a reduction in damage caused to a herbicide-sensitive plant when a photosensitizer is used and when a volatile herbicide or other phytotoxicant is a applied or otherwise present in a neighboring area, for example having been applied to a herbicide-resistant plant (e.g., soybeans) or other substrate. The photosensitizer can be co-applied with the volatile herbicide or separately applied to the herbicide-sensitive plant. Suitably, the herbicide composition including the photosensitizer can result in an injury level at 7-DAT, 10-DAT, 14-DAT, and/or 21-DAT for herbicide-sensitive plants which is about 80%, 50% or 30% or less and/or at least about 5%, 10%, 20%, 30%, or 40% of the injury level for the corresponding composition without the photosensitizer.

The composition, whether including volatile growth regulator herbicide, photosensitizer, or both, is often provided as a concentrate which is diluted with water (usually hard water) in the field prior to application to a target area. The diluted composition provides sufficient volatile growth regulator herbicide (when present) to kill or otherwise control the undesired plants in the target area. Likewise, the diluted composition provides sufficient photosensitizer (when present) to reduce the vapor effect of volatile herbicides, whether co-applied with or separately applied from the photosensitizer. The application rate of the herbicide can vary as appropriate for a particular herbicide and a particular target plant, but common rates range from about 0.01 kg a.i./ha to 4.0 kg a.i./ha, commonly applied (e.g., sprayed with a sprayer) at rates of about 40 L/ha to 300 L/ha of the dilute composition, with some undesired plants requiring more herbicide than others. The application rate of the photosensitizer similarly can vary as appropriate for a particular photosensitizer and/or a particular target plant to be protected, but common rates range from about 0.0001, 0.001, or 0.01 kg/ha to 0.04, 0.4, or 4.0 kg/ha.

The undesired plant in the target area is not particularly limited and can include any plant which is sensitive to the volatile growth regulator herbicide and which is desired to be killed, damaged, or otherwise controlled by the application of the herbicide. Sensitive plants generally include any plants susceptible to being killed, damaged, or otherwise controlled by the herbicide, regardless of whether the plants are natural varieties (e.g., naturally occurring wild type varieties, varieties bred for a particular trait) or genetically modified varieties to incorporate (heterologous) genetic traits related to something other than resistance to the herbicide. The undesired plant suitably can include one or more types of broadleaf weeds in the target area. Example broadleaf weeds include marestail, velvetleaf, and common lambsquarters. These examples are illustrative and the herbicide composition more generally can be used to control any undesired herbicide-sensitive plant.

In some embodiments, the target area also includes planted therein one or more desired plants (e.g., first or second desired plants) which are resistant or tolerant to the volatile growth regulator herbicide. The desired plant in the target area can represent a crop plant or other valuable plant in a field or other cultivated area where it is desired to eliminate of the undesired plant (e.g., where the undesired plant has an adverse effect on the desired plants and/or the undesired plant is aesthetically displeasing). In this case, the herbicide composition, with or without a photosensitizer, can be applied to the target area to control the undesired plant without substantially adversely affecting the desired plant therein (e.g., due to its resistance or tolerance to the volatile growth regulator herbicide). Resistant or tolerant plants include those plants which are generally not susceptible to control by the volatile growth regulator herbicide, for example as a result of one or more naturally occurring resistance or tolerance traits (e.g., traits in naturally occurring wild type varieties or natural varieties bred for a particular trait, whether or not related to herbicide resistance) and/or one or more (heterologous) genetic traits conferring herbicide resistance in a genetically modified plant. Examples of resistant or tolerant plants (e.g., as the desired plant) include resistant cash crops (e.g., resistant soybean, resistant corn, resistant canola, resistant cotton, resistant wheat; whether or not resistance results from a genetically modified trait, natural trait, or bred trait), tolerant cash crops (e.g., wheat; whether or not tolerance results from a genetically modified trait, natural trait, or bred trait), grasses such as turfgrasses (e.g., whether or not tolerance or resistance results from a genetically modified trait, natural trait, or bred trait). These examples are illustrative and the target area more generally can include any desired herbicide-resistant or herbicide-tolerant plants.

In some embodiments, the target area is adjacent to a collateral area that includes planted therein one or more additional desired plants (e.g., first or second desired plants) which are to be protected from the volatile growth regulator herbicide and which are sensitive to the volatile growth regulator herbicide. The additional desired plant can represent a crop plant or other valuable plant in a field or other cultivated area which is adjacent to the target area where it is desired to eliminate the undesired plant. In some embodiments, a composition containing the photosensitizer (e.g., but not volatile growth regulator herbicide) is applied to the collateral area and/or sensitive desired plants therein to protect the desired plants from phytotoxicants therein, for example volatile growth regulator herbicide from a neighboring target area. The proximity between the target area and the collateral area is not particularly limited. In some cases, the target area and the collateral area can be at least about 0.1 m, 1 m, 10 m, 100 m, or 1 km and/or about 1 m or less, 10 m or less, 100 m or less, 1 km or less, or 10 km or less from each other, for example within about 1 m to 10 m, 10 m to 100 m, 100 m to 1 km, or 1 km to 10 km of each other (e.g., within about 1 m, 10 m, 100 m, 1 km, or 10 km of each other). Because the vapor effect of the volatile growth regulator herbicide as applied to the target area is reduced or eliminated, damage to the desired plant in the collateral area is similarly reduced or eliminated based on a suppression of vapor effect of the herbicide, for example in the target area where applied and/or in a neighboring collateral area after volatile transport thereto. For example, damage to the desired plant in the collateral area is reduced relative that which would otherwise be observed resulting from a corresponding composition without the photosensitizer, for example as co-applied with the volatile herbicide to the target area or as separately applied without the volatile herbicide to the collateral area. In various embodiments, damage to the desired plant in the collateral area can be not more than 50%, 20%, 10%, 5%, 2% or 1% damage relative to a corresponding control composition or application without the photosensitizer. In cases where some minor vapor effect can still occur, the relative damage could be at least 0.5%, 1%, 2%, 5% or 10%, but less than one of the foregoing upper bounds. Sensitive desired plants in the collateral area generally include cash crops, ornamental plants, and wild plant life (e.g., varieties without any natural, bred, or transgenically introduced resistance or tolerance). Examples of sensitive desired plants in the collateral area include soybean plants, corn plants, sugar beet plants, tomato plants, cucumber plants, grape plants, cotton plants, melon plants, dry bean plants, potato plants, fruit plants (e.g., trees or bushes such as for cherry trees, apple trees, orange trees), and ornamental plants (e.g., flowers or otherwise). These examples are illustrative and the collateral area more generally can include any desired herbicide-sensitive plants.

The specific manner in which the undesired plant in the target area is controlled by the herbicide is not particularly limited. Control of the undesired plant generally corresponds to the intended herbicidal activity for the undesired plant, for example one or more of killing and/or damaging of the undesired plant, preventing or reducing further reproduction and/or growth of the undesired plant, etc. Conversely, the herbicide-sensitive desired plants, when present in the target or adjacent collateral areas, respectively, suitably are not substantially adversely affected or otherwise controlled by the herbicide (e.g., killed, damaged or injured) due to a reduction in or elimination of vapor effect of the herbicide from its area or substrate of application.

### EXAMPLES

The following examples illustrate the disclosed compositions and methods, but are not intended to limit the scope of any claims thereto.

Volatilization of herbicides from soils and plants can result in undesirable loss of the active herbicide ingredient as well as unintended injury to nearby plants. These examples illustrate herbicide compositions and methods according to the disclosure including a photosensitizer component to reduce the vapor effect of volatile herbicides from an area to which the herbicide composition is applied. Photosensitizer compounds such as riboflavin can photo-oxidize these herbicides and reduce their phytotoxicity from vapors. The examples below demonstrate this reduced vapor effect from the herbicide's volatility, from both soybean leaves and from bare soil, when riboflavin is present in a spray solution with a volatile herbicide. Herbicide-sensitive plants near to the point of application of the volatile herbicide composition exhibited a reduction in damage with the herbicide composition also included a riboflavin photosensitizer. The inclusion of riboflavin in the herbicide spray solution did not reduce the efficacy of the herbicide on weeds.

These examples illustrate a bioassay system for evaluating herbicide vapor effect after application to a plant substrates. A herbicide composition including a volatile growth regulator herbicide (dicamba) and one or more adjuvants was applied foliarly to (i) herbicide-resistant soybean plants, after which the vapor effect on nearby herbicide-sensitive tomato plants was investigated, or (ii) herbicide-sensitive weeds, after which the herbicide activity on the weeds was investigated. Visual evaluation of injury to the sensitive plants was evaluated 7, 10, 14, and/or 21 days after treatment/application (DAT) of the herbicide composition and continued growth under greenhouse conditions. Data were subjected to analysis of variance using PROC GLM in SAS.

The herbicide compositions were prepared and applied at a rate of 93.5 L/ha (10 gal/acre) and 172 kPa (25 psi) using a flat fan nozzle tip (TEEJET XR8001E or equivalent; available from Spraying Systems, Co., Wheaton, Ill.). In addition to riboflavin as a photosensitizer, the herbicide compositions included various other adjuvants as summarized in the tables below. “HFCS” is high fructose corn syrup. “REDDY IT” is an adjuvant including polyethoxylated phosphate esters, polyethoxylated amines, and methylated seed oils (available from Adjuvants Plus, Kingsville, ON). “DRIFTKNOT” is an adjuvant including modified vegetable oil, petroleum oil, and alkyl phenol ethoxylate (available from Adjuvants Plus).

### Example 1—Tomato Injury and Riboflavin Vapor Effect on Dicamba from Soybean Application

Herbicide compositions including an XTENDIMAX formulation of dicamba (available from Monsanto, Creve Coeur, Mo.) were sprayed onto leaves and surrounding soil of herbicide-resistant ASGROW 21X7 soybean plants (available from Associated Seed Growers, Inc., Creve Coeur, Mo.). The herbicide compositions included other adjuvants as summarized below. Herbicide-sensitive tomato plants (variety Early Girl) were inserted into the spray area with the soybeans after spraying (0 DAT), three days after spraying (3 DAT), or five days after spraying (5 DAT). The tomato plants were exposed to vapors emitted from the treated soybean plants for 24 hours, and then the tomato plants were removed from the soybean/spray area and transferred to a separate bench for growth and evaluation. The tomato plants were evaluated for injury at 7, 10, and 14 DAT.

The results are summarized in Table 1. As shown in treatments 16 and 24, higher riboflavin delivery along with HFCS is sufficient to significantly reduce tomato plant injury for the 3- and 5-day tests, relative to herbicide-only compositions and herbicide compositions containing only HFCS as an adjuvant.

TABLE 1
Tomato Injury and Riboflavin Vapor Effect on Dicamba for Example 1
VOL 19-1a and 19-1.2a-EFFECT of RIBOFLAVIN on XTENDIMAX VOLATILTY from SOYBEAN LEAVES-COMBINED DATA-
RUN 1 and 2
10 gpa and 25 psi

| TRT | | % INJURY | % INJURY % INJURY | | TRT |
|---|---|---|---|---|---|
| NO. | TREATMENT | 7 DAT | 10 DAT | 14 DAT | NO. |
| 1 | UNTREATED CHECK | 0 e | 0 i | 0 j | 1 |
| 2 | DXVG°-SPRAY DAY | 41 ab | 53 ab | 60 abc | 2 |
| 3 | DXVG + 1% v/v HFCS^{£}-SPRAY DAY | 40 ab | 52 ab | 53 bcd | 3 |
| 4 | DXVG + 1% v/v HFCS + LOW RIBOFLAVIN*-SPRAY DAY | 46 a | 59 a | 61 ab | 4 |
| 5 | DXVG + 1% v/v HFCS + HIGH RIBOFLAVIN**-SPRAY DAY | 45 a | 53 ab | 57 abcd | 5 |
| 6 | DXVG + 1% v/v HFCS + 1% v/v DRIFTKNOT [symbol] + HIGH RIBOFLAVIN-SPRAY DAY | 27 abc | 47 abc | 43 de | 6 |
| 7 | DXVG + 1% v/v HFCS + 1% v/v REDDY- [symbol] + HIGH RIBOFLAVIN-SPRAY DAY | 28 ab | 50 ab | 45 cde | 7 |
| 8 | DXVG + 1% v/v HFCS + EXTRA-HIGH RIBOFLAVIN***-SPRAY DAY | 40 ab | 50 ab | 70 a | 8 |
| 9 | UNTREATED CHECK | 0 e | 0 i | 0 j | 9 |
| 10 | DXVG-3^{RD} DAY AFTER TRT | 27 abc | 30 cde | 34 efg | 10 |
| 11 | DXVG + 1% v/v HFCS-3^{RD} DAY AFTER TRT | 29 ab | 38 bcd | 38 ef | 11 |
| 12 | DXVG + 1% v/v HFCS + LOW RIBOFLAVIN-3^{RD} DAY AFTER TRT | 31 ab | 23 defg | 34 efg | 12 |
| 13 | DXVG + 1% v/v HFCS + HIGH RIBOFLAVIN-3^{RD} DAY AFTER TRT | 26 abc | 26 defg | 24 fghi | 13 |
| 14 | DXVG + 1% v/v HFCS + 1% v/v DK + HIGH RIBOFLAVIN-3^{RD} DAY AFTER TRT | 5 de | 0 i | 17 hi | 14 |
| 15 | DXVG + 1% v/v HFCS + 1% v/v R-I + HIGH RIBOFLAVIN-3^{RD} DAY AFTER TRT | 5 de | 8 ghi | 22 ghi | 15 |
| 16 | DXVG + 1% v/v HFCS + EXTRA-HIGH RIBOFLAVIN-3^{RD} DAY AFTER TRT | 0 e | 3 hi | 17 hi | 16 |
| 17 | UNTREATED CHECK | 0 e | 0 i | 0 j | 17 |
| 18 | DXVG-5^{th} DAY AFTER TRT | 27 abc | 28 def | 33 efg | 18 |
| 19 | DXVG + 1% v/v HFCS-5^{th} DAY AFTER TRT | 28 ab | 27 def | 30 efghi | 19 |
| 20 | DXVG + 1% v/v HFCS + LOW RIBOFLAVIN-5^{th} DAY AFTER TRT | 27 abc | 31 cde | 32 efgh | 20 |
| 21 | DXVG + 1% v/v HFCS + HIGH RIBOFLAVIN-5^{th} DAY AFTER TRT | 21 bcd | 27 def | 24 fghi | 21 |
| 22 | DXVG + 1% v/v HFCS + 1% v/v DRIFTKNOT + HIGH RIBOFLAVIN-5^{th} DAY AFTER | 7 cde | 20 efgh | 15 ij | 22 |
| | TRT | | | | |
| 23 | DXVG + 1% v/v HFCS + 1% v/v REDDY-IT + HIGH RIBOFLAVIN-5^{th} DAY AFTER TRT | 0 e | 15 efghi | 17 hi | 23 |
| 24 | DXVG + 1% v/v HFCS + EXTRA-HIGH RIBOFLAVIN-5^{th} DAY AFTER TRT | 0 e | 12 fghi | 15 ij | 24 |
| | LSD (0.05) | 21 | 18 | 16 | |

3 reps
°DXVG = XTENDIMAX formulation of dicamba (2.9 lb a.e./gal) applied at 0.75 lb a.e./A
^{£}HFCS is high fructose corn syrup, 2012
*LOW Riboflavin is applied at 1:10 ratio of riboflavin to herbicide
**HIGH Riboflavin is applied at 1:5 ratio of riboflavin to herbicide
***EXTRA-HIGH Riboflavin applied at 3:5 ration of riboflavin to herbicide-run 2 only [symbol]
DRIFTKNOT—a product of Adjuvants Plus-2019 [symbol]
—a product of Adjuvants Plus
Sprayed onto new and used (run 1) field soil filled cake pots containing Asgrow 21x7 plants
Tomatoes (VARIETY Early Girl) inserted starting on spray day, then 3 and 5 days after treatment
Tomatoes exposed to vapors coming off soybean plants for 24 hours before removal and transferal to bench away from cake pots
NOTE:
RUN 1 (19-1 A) rate of HFCS was 1.25% v/v; RUN 2 (19-1.2a) rate of HFCS was changed to 1% v/v
RUN 1 NOTES:
Experiment consists of treatments 1-5 only
Greenhouse was extremely hot during tomato exposure stages of experiment
0 DAT tomatoes were at or slightly above soybean canopy
3 DAT tomatoes were inserted into soybeans according to height of tomato . . . tall into tall, medium into medium, small into small
ALL 5 DAT tomatoes were 1 inch below canopy
RUN 2 NOTES:
Greenhouse temperatures were 41-43 degrees C. for the time of tomato insertion and removal
0 DAT tomatoes were at or slightly above soybean canopy
3 DAT TOMATO PLANTS were at or slightly below the height of soybean canopy
5 DAT TOMATO PLANTS were below the soybean canopy at insertion
Targeting a period of sunny weather for spray day & after, which may have been partly to mostly cloudy

### Example 2—Tomato Injury and Riboflavin Vapor Effect on Dicamba from Soybean Application

Herbicide compositions including an ENGENIA formulation of dicamba (available from BASF, Ludwigshafen, Germany) were sprayed onto leaves and surrounding soil of herbicide-resistant ASGROW 21X7 soybean plants (available from Associated Seed Growers, Inc., Creve Coeur, Mo.). The herbicide compositions included other adjuvants as summarized below. Herbicide-sensitive tomato plants (variety Early Girl) were inserted into the spray area with the soybeans after spraying (0 DAT) or three days after spraying (3 DAT). The tomato plants were exposed to vapors emitted from the treated soybean plants for 24 hours, and then the tomato plants were removed from the soybean/spray area and transferred to a separate bench for growth and evaluation. The tomato plants were evaluated for injury at 7, 10, and 14 DAT.

The results are summarized in Table 2 below. As shown in treatments 6, 7, and 14, riboflavin delivery along with other adjuvants reduces tomato plant injury for the 0- and 3-day tests, relative to herbicide-only compositions and herbicide compositions containing only HFCS as an adjuvant. Although not tested in Example 2, it is believed that higher riboflavin application rates would reduce the herbicide vapor effect, even without additional volatility suppression adjuvants, for example as illustrated above for Example 1 at extra-high riboflavin levels.

TABLE 2
Tomato Injury and Riboflavin Vapor Effect on Dicamba for Example 2
VOL 19-1.1b-EFFECT of RIBOFLAVIN on ENGENIA VOLATILTY from SOYBEAN LEAVES-RUN 1
10 gpa and 25 psi

| TRT | | % INJURY | % INJURY | % INJURY | TRT |
|---|---|---|---|---|---|
| NO. | TREATMENT | 7 DAT | 10 DAT | 14 DAT | NO. |
| 1 | UNTREATED CHECK | 0 e | 0 d | 0 e | 1 |
| 2 | DENG°-INSERTION SPRAY DAY | 35 ab | 35 b | 37 bc | 2 |
| 3 | DENG + 1.25% v/v HFCS^{£}-INSERTION SPRAY DAY | 37 ab | 37 ab | 45 a | 3 |
| 4 | DENG + 1.25% v/v HFCS + LOW RIBOFLAVIN*-INSERTION SPRAY DAY | 37 ab | 38 ab | 42 ab | 4 |
| 5 | DENG + 1.25% v/v HFCS + HIGH RIBOFLAVIN**-INSERTION SPRAY DAY | 32 bc | 37 ab | 36 bc | 5 |
| 6 | DENG + 1.25% v/v HFCS + HIGH RIBOFLAVIN + 1% v/v DRIFTKNOT [symbol] - | 22 d | 25 c | 23 d | 6 |
| | INSERTION SPRAY DAY | | | | |
| 7 | DENG + 1.25% v/v HFCS + HIGH RIBOFLAVIN + 1% v/v REDDY- [symbol] -INSERTION | 23 cd | 25 c | 23 d | 7 |
| | SPRAY DAY | | | | |
| 8 | UNTREATED CHECK | 0 e | 0 d | 0 e | 8 |
| 9 | DENG°-3^{RD} DAY AFTER TRT | 33 ab | 40 ab | 37 bc | 9 |
| 10 | DENG + 1.25% v/v HFCS-3^{RD} DAY AFTER TRT | 38 ab | 37 ab | 35 c | 10 |
| 11 | DENG + 1.25% v/v HFCS + LOW RIBOFLAVIN-3^{RD} DAY AFTER TRT | 38 ab | 39 ab | 43 ab | 11 |
| 12 | DENG + 1.25% v/v HFCS + HIGH RIBOFLAVIN-3^{RD} DAY AFTER TRT | 42 a | 43 a | 45 a | 12 |
| 13 | DENG + 1.25% v/v HFCS + HIGH RIBOFLAVIN + 1% v/v DRIFTKNOT-3^{RD} DAY AFTER | 37 ab | 37 ab | 35 c | 13 |
| | TRT | | | | |
| 14 | DENG + 1.25% v/v HFCS + HIGH RIBOFLAVIN + 1% v/v REDDY-IT-3^{RD} DAY AFTER | 20 d | 22 c | 20 d | 14 |
| | TRT LSD (0.05) | 9 | 8 | 6 | |

NOTE:
5 DAT insertion was skipped due to tomatoes being too small and would have been seriously under canopy
°DENG = ENGENIA formulation of dicamba (2.9 lb a.e./gal) applied at 0.75 lb a.e./A
^{£}HFCS is high fructose corn syrup, 2012
*LOW Riboflavin is applied at 1:10 ratio of riboflavin to herbicide
**HIGH Riboflavin is applied at 1:5 ratio of riboflavin to herbicide [symbol]
DRIFTKNOT—a product of Adjuvants Plus-2019 [symbol]
—a product of Adjuvants Plus
Sprayed onto (fresh) field soil filled cake pots containing Asgrow 21X7 plants PD = ~3 Jun. 2019
Tomatoes (VARIETY Early Girl) inserted starting on spray day, then 3 days after treatment.
Tomatoes will be exposed to vapors coming off soybean plants for 24 hours before removal and transferal to bench away from cake pots.
SPRAY DAY insertion plants: 2 Reps at or slightly above canopy, 1 rep slightly below canopy
3 DAT tomatoes were inserted into soybeans according to height of tomato . . . tall into tall, medium into medium, small into small

### Example 3—Effect of Riboflavin on Dicamba Efficacy for Velvetleaf Application

Herbicide compositions including an XTENDIMAX formulation of dicamba (available from Monsanto, Creve Coeur, Mo.) were sprayed onto velvetleaf weeds. The herbicide compositions included other adjuvants as summarized below. The velvetleaf weeds were evaluated for injury at 7, 10, 14, and 21 DAT

The results are summarized in Table 3 below. The data illustrate that when riboflavin is used alone or in combination with other adjuvants to reduce herbicide vapor effect, the inclusion of riboflavin and other adjuvants does not significantly affect the herbicide's activity against its intended weed target plant, meaning that the herbicide continues to perform its intended function without adverse effect from the riboflavin photosensitizer.

TABLE 3
Dicamba Efficacy for Velvetleaf Injury with Riboflavin for Example 3
PLT 19-1.1A+ and 19-1.3A++-EFFECT of RIBOFLAVIN on XTENDIMAX EFFICACY on VELVETLEAF-COMBINED DATA-
10 gpa and 25 psi

| TRT | | % INJURY | % INJURY | % INJURY | % INJURY | TRT |
|---|---|---|---|---|---|---|
| NO. | TREATMENT | 7 DAT | 10 DAT | 14 DAT | 21 DAT | NO. |
| 1 | UNTREATED CHECK | 0 d | 0 c | 0 d | 0 e | 1 |
| 2 | DXVG° | 44 b | 54 b | 65 bc | 59 d | 2 |
| 3 | DXVG + 1 % v/v HFCS^{£} | 44 b | 53 b | 62 c | 66 be | 3 |
| 4 | DXVG + 1% v/v HFCS + LOW RIBOFLAVIN* | 45 b | 55 b | 66 bc | 73 a | 4 |
| 5 | DXVG + 1% v/v HFCS + HIGH RIBOFLAVIN** | 41 c | 55 b | 65 bc | 69 abc | 5 |
| 6 | DXVG + 1% v/v HFCS + 1% v/v DRIFTKNOT [symbol] | 40 c | 53 b | 67 bc | 63 cd | 6 |
| 7 | DXVG + 1% v/v HFCS + 1% v/v DRIFTKNOT + HIGH | 43 bc | 51 b | 63 bc | 65 bc | 7 |
| | RIBOFLAVIN | | | | | |
| 8 | DXVG + 1% v/v HFCS + 1% v/v REDDY- [symbol] | 42 bc | 55 b | 68 b | 65 be | 8 |
| 9 | DXVG + 1% v/v HFCS + 1% v/v REDDY-IT + HIGH RIBOFLAVIN | 48 a | 60 a | 75 a | 73 a | 9 |
| 10 | DXVG + 1% v/v HFCS + EXTRA HIGH RIBOFLAVIN*** | 40 c | 55 b | 67 bc | 70 ab | 10 |
| | LSD (0.05) | 3 | 5 | 6 | 6 | |

°DXVG = XTENDIMAX formulation of dicamba (2.9 lb a.e./gal) applied at 0.25 lb a.e./A
^{£}HFCS is high fructose corn syrup, 2012
*LOW Riboflavin is applied at 1:10 ratio of riboflavin to herbicide
**HIGH Riboflavin is applied at 2:10 ratio of riboflavin to herbicide [symbol]
DRIFTKNOT—a product of Adjuvants Plus-2019 [symbol]
—a product of Adjuvants Plus
***EXTRA HIGH Riboflavin is applied as 6:10 ratio of riboflavin to herbicide
+PLT 19-1.1A contained treatments 1-5, 7 and 9
The rate of riboflavin in this experiment was 3 times that of 19-1.3a, due to it being the CROP rate
++PLT 19-1.3A contained treatments 1-10; Means for trt 6, 8, and 10 contain only 1 set of data instead of 2
3 reps due to limited uniform plants
Plants were significantly larger than those in 19-1.1A

### Example 4—Effect of Riboflavin on Dicamba Efficacy for Lambsquarters Application

Herbicide compositions including an XTENDIMAX formulation of dicamba (available from Monsanto, Creve Coeur, Mo.) were sprayed onto common lambdsquarters weeds. The herbicide compositions included other adjuvants as summarized below. The velvetleaf weeds were evaluated for injury at 7, 10, 14, and 21 DAT.

The results are summarized in Table 4 below. The data illustrate that when riboflavin is used alone or in combination with other adjuvants to reduce herbicide vapor effect, the inclusion of riboflavin and other adjuvants does not significantly affect the herbicide's activity against its intended weed target plant, meaning that the herbicide continues to perform its intended function without adverse effect from the riboflavin photosensitizer.

TABLE 4
Dicamba Efficacy for Lambsquarters Injury with Riboflavin for Example 4
PLT 19-1.2A EFFECT of RIBOFLAVIN on XTENDIMAX EFFICACY-
COMMON LAMBSQUARTERS-COMBINED DATA-RUN 1 AND 2
10 gpa and 25 psi

| TRT | | % INJURY | % INJURY | % INJURY | % INJURY | TRT |
|---|---|---|---|---|---|---|
| NO. | TREATMENT | 7 DAT | 10 DAT | 14 DAT | 21 DAT | NO. |
| 1 | UNTREATED CHECK | 0 d | 0 d | 0 e | 0 c | 1 |
| 2 | DXVG° | 38 c | 44 bc | 47 c | 28 b | 2 |
| 3 | DXVG + 1% v/v HFCS^{£} | 40 c | 43 bc | 42 cd | 35 b | 3 |
| 4 | DXVG + 1% v/v HFCS + LOW RIBOFLAVIN* | 42 bc | 44 bc | 42 cd | 40 b | 4 |
| 5 | DXVG + 1% v/v HFCS + HIGH RIBOFLAVIN** | 39 c | 40 c | 41 d | 36 b | 5 |
| 6 | DXVG + 1% v/v HFCS + 1% v/v DRIFTKNOT [symbol] | 47 ab | 45 bc | 54 b | 58 a | 6 |
| 7 | DXVG + 1% v/v HFCS + 1% v/v DRIFTKNOT + HIGH | 42 bc | 47 b | 57 b | 58 a | 7 |
| | RIBOFLAVIN | | | | | |
| 8 | DXVG + 1% v/v HFCS + 1% v/v REDDY- [symbol] | 51 a | 62 a | 66 a | 70 a | 8 |
| 9 | DXVG + 1% v/v HFCS + 1% v/v REDDY-IT + HIGH RIBOFLAVIN | 48 a | 59 a | 64 a | 63 a | 9 |
| | LSD (0.05) | 5 | 5 | 6 | 14 | |

NOTE:
RUN 1: Only three reps due to limited number of uniform plants-blocked by size: 7.25, 9, and 12 inch heights
RUN 2: Plants blocked by size: 2 reps 10.75, 12.5, and 14.5 inch heights
°DXVG = XTENDIMAX formulation of dicamba (2.9 lb a.e./gal) applied at 0.25 lb a.e./A
^{£}HFCS is high fructose corn syrup, 2012
*LOW Riboflavin is applied at 1:10 ratio of riboflavin to herbicide
**HIGH Riboflavin is applied at 2:10 ratio of riboflavin to herbicide [symbol]
DRIFTKNOT—a product of Adjuvants Plus-2019 [symbol]
—a product of Adjuvants Plus

### Example 5—Effect of Riboflavin on Vapor Effect of Phytotoxicants

A greenhouse was observed to have an unknown, atmospheric phytotoxicant contaminant causing injury to plants in the greenhouse. A series of fresh tomato plants was placed in the greenhouse. Some tomato plants were sprayed with an aqueous solution containing riboflavin (i.e., but no herbicide as in the above example compositions), while some control tomato plants were not sprayed with the riboflavin composition or otherwise treated. After prolonged exposure in the greenhouse, typically when the tomato plants reach a height of about 12 cm to 18 cm, the control tomato plants began to exhibit plant injury, while the riboflavin-treated tomato plants did not. This illustrates the ability of riboflavin and other photosensitizers to be used as a protect treatment even when not co-applied with a volatile herbicide as in Examples 1-4.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. A method for reducing vapor effect of volatile herbicides, the method comprising:
(a) providing a composition comprising: (i) water, (ii) a volatile growth regulator herbicide, and (iii) a photosensitizer selected from the group consisting of flavins, flavonoids, derivatives thereof, and combinations thereof;
(b) applying the composition to a target area comprising: (i) optionally a first desired plant which is resistant or tolerant to the volatile growth regulator herbicide, and (ii) an undesired plant which is to be targeted by the volatile growth regulator herbicide and which is sensitive to the volatile growth regulator herbicide; and
(c) controlling the undesired plant in the target area with the applied composition;
wherein the vapor effect of the volatile growth regulator herbicide in the target area is reduced or eliminated relative to a corresponding composition without the photosensitizer applied to the target area.

2. The method of claim 1, wherein the photosensitizer is riboflavin.

3. The method of claim 1, wherein the photosensitizer is present in the composition in an amount ranging from 0.01 wt. % to 10 wt. %.

4. The method of claim 1, wherein a ratio of photosensitizer : volatile growth regulator herbicide in the composition is in a range of 1:100 to 1:1.

5. The method of claim 1, wherein the target area comprises the first desired plant which is resistant or tolerant to the volatile growth regulator herbicide.

6. The method of claim 1, wherein the target area is adjacent to a collateral area comprising a second desired plant which is to be protected from the volatile growth regulator herbicide and which is sensitive to the volatile growth regulator herbicide.

7. The method of claim 6, wherein damage to the second desired plant in the collateral area is reduced or eliminated relative to a corresponding composition without the photosensitizer applied to the target area.

8. The method of claim 1, wherein applying the composition to the target area comprises applying the composition to at least one of a surface the undesired plant and soil around the undesired plant.

9. The method of claim 1, wherein the volatile growth regulator herbicide comprises a weak acid herbicide or a derivative thereof.

10. The method of claim 1, wherein the volatile growth regulator herbicide comprises at least one of an aromatic and a heteroaromatic group.

11. The method of claim 1, wherein the composition comprises two or more types of volatile growth regulator herbicides in admixture.

12. The method of claim 1, wherein volatile growth regulator herbicide comprises one or more of 2,4-dichlorophenoxyacetic acid (2,4-D), 2,4,5-trichlorophenoxyacetic acid (2,4,5-T), 2-methyl-4-chlorophenoxyacetic acid (MCPA), 2-(2-methyl-4-chlorophenoxy)propionic acid (mecoprop, MCPP), 4-(4-chloro-o-tolyloxy)butyric acid (MCPB), 2-(2,4-dichlorophenoxy)propionic acid (dichlorprop, 2,4-DP), (2,4-dichlorophenoxy)butyric acid (2,4-DB), 3,6-dichloro-2-methoxybenzoic acid (dicamba), 4-amino-3,5,6-trichloropicolinic acid (picloram), 3,5,6-trichloro-2-pyridinyloxyacetic acid (triclopyr), and 3,6-dichloro-2-pyridinecarboxylic acid (clopyralid).

13. The method of claim 1, wherein the volatile growth regulator herbicide has a vapor pressure of at least 1×10⁻⁶ Pa in the composition.

14. The method of claim 1, wherein the volatile growth regulator herbicide is present in the composition in an amount ranging from 0.01 wt. % to 10 wt. %.

15. The method of claim 1, wherein the composition further comprises a monosaccharide.

16. The method of claim 15, wherein monosaccharide comprises fructose.

17. The method of claim 15, wherein monosaccharide comprises one or more of fructose, glucose, and mannose.

18. The method of claim 15, wherein monosaccharide comprises high-fructose corn syrup.

19. The method of claim 15, wherein the composition is substantially free from saccharides other than the monosaccharide.

20. The method of claim 15, wherein the monosaccharide is present in the composition in an amount ranging from 0.1 wt. % to 10 wt. %.

21. The method of claim 1, wherein the composition further comprises an additional herbicide which is not a volatile growth regulator herbicide.

22. The method of claim 1, wherein the composition further comprises at least one of a water conditioner and a surfactant.

23. The method of claim 1, wherein the undesired plant to be targeted comprises one or more broadleaf weeds.

24. A method for reducing vapor effect of phytotoxicants, the method comprising:
(a) providing a first composition comprising: (i) water and (ii) a photosensitizer selected from the group consisting of flavins, flavonoids, derivatives thereof, and combinations thereof;
(b) applying the first composition to a collateral area comprising a first desired plant which is to be protected from a phytotoxicant and which is sensitive to the phytotoxicant; and
(c) reducing or eliminating via the photosensitizer the vapor effect of the phytotoxicant in the collateral area and on the first desired plant relative to a corresponding first desired plant without the photosensitizer applied to the collateral area.

25. The method of claim 24, further comprising:
(d) providing a second composition comprising: (i) water, and (ii) a volatile growth regulator herbicide;
(e) applying the second composition to a target area adjacent to the collateral area, the target area comprising: (i) optionally a second desired plant which is resistant or tolerant to the volatile growth regulator herbicide, and (ii) an undesired plant which is to be targeted by the volatile growth regulator herbicide and which is sensitive to the volatile growth regulator herbicide; and
(f) controlling the undesired plant in the target area with the applied second composition;
wherein at least a portion of the volatile growth regulator herbicide applied in the target area volatilizes and is transported to the collateral area, in which the vapor effect of the volatile growth regulator herbicide is reduced or eliminated by the photosensitizer applied to the collateral area.

26. The method of claim 24, wherein:
the photosensitizer is riboflavin; and
the phytotoxicant comprises a volatile growth regulator herbicide.

27. A composition comprising:
(a) water;
(b) a volatile growth regulator herbicide;
(c) a photosensitizer selected from the group consisting of flavins, flavonoids, derivatives thereof, and combinations thereof; and
(d) optionally a monosaccharide;
wherein the vapor effect of the volatile growth regulator herbicide from a target area to which the composition is applied is reduced or eliminated relative to a corresponding composition without the photosensitizer applied to the target area.

28. The composition of claim 27, wherein the volatile growth regulator herbicide and the photosensitizer are present in the composition at concentrations suitable for application to a target area comprising an undesired plant which is to be targeted by the volatile growth regulator herbicide and which is sensitive to the volatile growth regulator herbicide.

29. The composition of claim 27, wherein the volatile growth regulator herbicide and the photosensitizer are present in the composition at elevated concentrations unsuitable without prior dilution for application to a target area comprising an undesired plant which is to be targeted by the volatile growth regulator herbicide and which is sensitive to the volatile growth regulator herbicide.
